(19) United States
(12) Patent Application Publication
(10) Pub. No.: US 2021/0086893 A1
(43) Pub. Date: Mar. 25, 2021

(54) CONVERTIPLANE

(71) Applicant: OBSCHESTVO S OGRANICHENNOI OTVETSTVENNOSTYU "TEKHNOVETER" [RU/RU], Moscow (RU)

(72) Inventor: Ellina Vladimirovna ZIMENSKAYA, Kazan (RU)

(73) Assignee: OBSCHESTVO S OGRANICHENNOI OTVETSTVENNOSTYU "TEKHNOVETER" [RU/RU], Moscow (RU)

(21) Appl. No.: 16/971,750

(22) PCT Filed: Dec. 17, 2018
(86) PCT No.: PCT/RU2018/050163

§ 371 Date: Aug. 21, 2020

(30) Foreign Application Priority Data
Mar. 5, 2018 (RU) 2018108062

(51) Int. Cl. B64C 29/00; B64C 39/08; B64D 27/24; B64D 27/04; B64D 27/10; B64C 27/50; B64D 27/16; B64C 5/06; B64C 25/00; B64D 17/80

(52) U.S. Cl. CPC B64C 29/0033; B64C 39/08; B64D 27/24; B64D 27/04; B64D 17/80; B64C 27/50; B64D 27/16; B64C 5/06; B64C 25/00; B64D 27/10

(57) ABSTRACT

The invention relates to the field of aviation, particularly to designs for vertical take-off and landing aircraft. A convertiplane comprises a fuselage, a pair of wings (a fore wing and an aft wing), propulsion systems comprising engines and propellers, a vertical stabilizer, a landing gear, and rotatable pylons. Two lifting propulsion systems are disposed on pylons having two degrees of freedom relative to the yaw and pitch angle on each side of the fuselage so as to be capable of being fixed in position and of retracting forward or backward into fuselage niches during horizontal flight. A marching propulsion system is installed on a pylon having one degree of freedom relative to the pitch angle so as to be capable of being fixed in position, or is completely fixed, and is capable of being disposed in either the nose part or the tail part of the fuselage, and likewise on the leading edge or the trailing edge of the vertical stabilizer. The invention allows for increasing reliability and service life, increasing flight distance, and decreasing production costs for the convertiplane.

### FIELD OF THE INVENTION

The invention relates to aviation field, in particular, to vertical take-off and landing aircraft structures. The invention can be used in all spheres of traditional use of airplanes, helicopters, convertiplanes, unmanned aircraft.

### BACKGROUND

It is known a convertiplane (Patent RU No. 2456209 C1. IPC B64C37/00—20 Jul. 2012, Bulletin No. 20) comprising a fuselage, wing, engines, tail unit, landing gear. Pylons configured to rotate are located on the wing. Two front engines are installed on pylons. Rear engine is installed on fin pylon. Landing gear legs are combined with wing pylons and fin respectively. Aircraft balance is ensured in all flight modes.

The disadvantageous features of this technical solution are low loadlifting capacity, low flight range and time due to low efficiency of propulsion systems, since they are lifting and propulsion at the same time, and also excess engine capacity in horizontal flight, consequently, their forced operation at reduced efficiency.

The most close to the claimed technical solution is the convertiplane (Patent RU No. 2635431 C1, IPC B64C37/00—13 Nov. 2017, Bulletin No. 32) comprising fuselage, a pair of wings: front and rear, propulsion systems comprising engines and propellers, landing gear, pylons configured to rotate, two lifting propulsion systems located on pylons with two pitch attitude/bank degrees of freedom on each side of fuselage configured to fix position and retract forward or back into fuselage cavity when in horizontal flight. Propulsion system is installed on the pylon with two pitch attitude/bank degrees of freedom and configured to fix position in the fuselage rear part. This patent is taken as a prototype.

The disadvantageous features of this convertiplane are as follows:

1. Heavy weight and high resistance of propulsion system pylon.

2. When using combustion engines in the propulsion system, the control system technical complexity increases. This is due to the fact that combustion engines are considerably more speed inert compared to electrical engines, consequently, it is not possible to use combustion engines in control loops without controllable pitch propellers in case of conventional engine and gas-turbine engine, or controllable nozzle in case of using jet engine.

### SUMMARY OF THE INVENTION

The purpose of the claimed invention is creation of the simple design transportation convertiplane balanced in all flight modes and able to fly horizontally, take off and land vertically and hover in place. The convertiplane utility is in ability to take off and land on the minimum dimensions site and in reducing of transportation time due to ability to deliver payload as close to the consumer as possible.

Technical Result—Improving the Structure Reliability, Increasing the Loadlifting Capacity, Flight Range and Time and Reducing the Convertiplane Cost.

The said technical result is achieved due to a convertiplane comprising a fuselage, a pair of wings: fore and aft, a fin, two lifting propulsion systems comprising engines with propellers, located on pylons having two degrees of freedom with respect to angles of pitch and yaw on sides of the fuselage, configured to be fixed in a position and retractable during horizontal flight into a fuselage cavity, a marching propulsion system comprising an engine, the marching propulsion system is located on a marching pylon, wherein the marching pylon has only one pitch attitude degree of freedom and configured to be fixed in a position, or has no degree of freedom.

In some embodiments, the engines of the lifting propulsion systems are made as electric motors, or as reciprocating internal combustion engines, or as gas turbine engines. In some embodiments, the propellers of the engines of the lifting propulsion systems are made foldable. In some embodiments, the engine of the marching propulsion system comprises a jet engine and gas rudders that change a thrust vector in a vertical plane. In some embodiments, the convertiplane is made with a landing gear or with a parachute.

The advantage ensured by the foregoing set of features is decreasing of technical complexity, cost reduction and improving the reliability and also decreasing the empty convertiplane weight and increasing flight range and time. It ensures by reducing the marching propulsion system pylon degrees of freedom and by full or partial exclusion of the propulsion system from the convertiplane control loops.

### BRIEF DESCRIPTION OF THE DRAWINGS

The essence of the invention is supported by the drawings illustrating as follows:

FIG. 1—General view of the convertiplane at takeoff and landing mode. The marching propulsion system pylon has one degree of freedom;

FIG. 2—Convertiplane acceleration;

FIG. 3—General view of the convertiplane at horizontal flight. Lifting propulsion systems are retracted into fuselage niches (cavity);

FIG. 4—General view of the convertiplane at takeoff and landing mode. The propulsion system is fixed;
where 1—fuselage;
2—front wing;
3—rear wing;
4—fin;
5—lifting propulsion systems;
6—marching propulsion system;
7, 8—differential aerodynamic controls;
9—lifting propulsion system pylon;
10—marching propulsion system pylon (marching pylon);
11—fuselage cavity for retraction of lifting propulsion systems.

### DETAILED DESCRIPTION OF THE INVENTION

The current invention comprises a fuselage 1 designed for arrangement of payload, elements of control system and other systems; front wing 2 and rear wing 3; fin 4; lifting propulsion systems 5 starting the engine and propeller, located on swiveling pylons 9 on each side pf fuselage to generate lifting force at takeoff/landing modes; propulsion system 6 comprising engine and propeller or without propeller, located on pylon 10 configured to be located in the fuselage front or rear parts and also on the fin front or rear edges; differential aerodynamic controls 7 and 8 for the convertiplane horizontal flight control; fuselage cavity 11 for retraction of lifting propulsion systems.

The current invention has several features:

1. The marching propulsion system pylon (marching pylon) has either one pitch attitude degree of freedom or no one degree of freedom.

2. If the marching pylon has one degree of freedom, the convertiplane is longitudinally controlled by the propulsion system speed, collective pitch (if a controllable pitch propeller is installed) and by pitch attitude rotation of the marching pylon and also by means of lifting propulsion systems and their pylons.

3. When the marching pylon is fixed and the propulsion system comprises a jet engine and gas rudders that change a thrust vector in a vertical plane, the convertiplane is longitudinally controlled by engine thrust, gas rudders that change a thrust vector in a vertical plane, and also by means of lifting propulsion systems and their pylons.

4. The convertiplane is controlled at bank takeoff and landing mode by pitch attitude differential rotation of lifting propulsion systems.

5. If the propulsion system is fixed and there are no devices rotating the propulsion system thrust in vertical plane, the convertiplane is longitudinally controlled by bank/pitch attitude rotation of the lifting propulsion system pylons, and also by lifting engines speed, and in case of controllable pitch propellers—by pitch of these propellers.

The device operates as follows: there are three convertiplane flight modes: takeoff and landing mode, acceleration mode and horizontal flight.

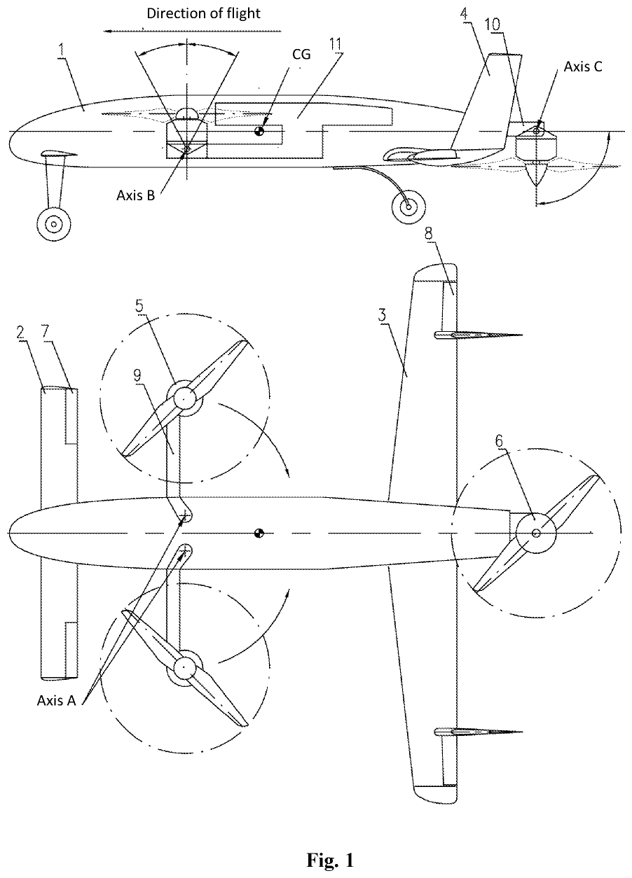

If the marching pylon has one degree of freedom, in takeoff and landing mode (FIG. 1) all three propulsion systems operate and are installed into “up” working position. Control is performed by rotation of propulsion systems relative to A and B axes (bank/pitch attitude) and by rotation of the propulsion system relative to C-axis (pitch attitude). Deflection is performed by servo drives. Besides, the convertiplane is controlled by changing engines speed.

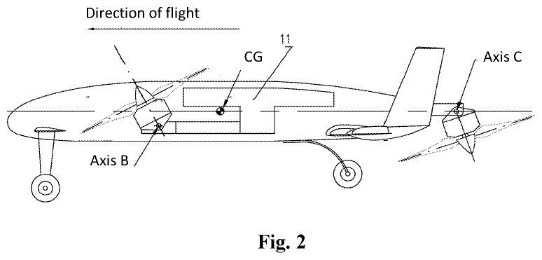

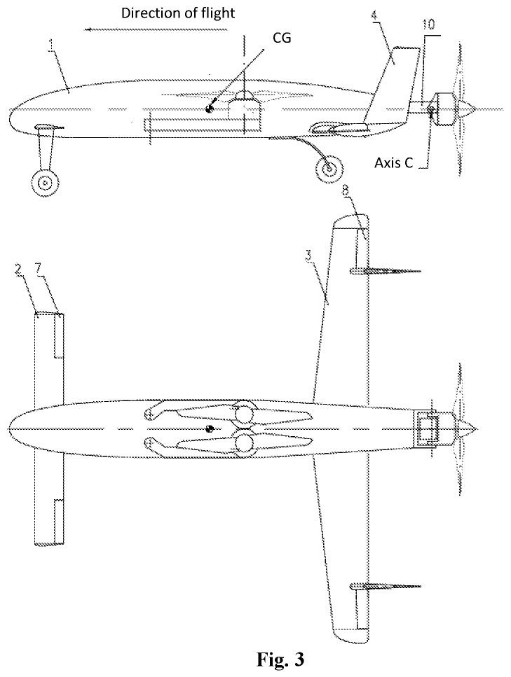

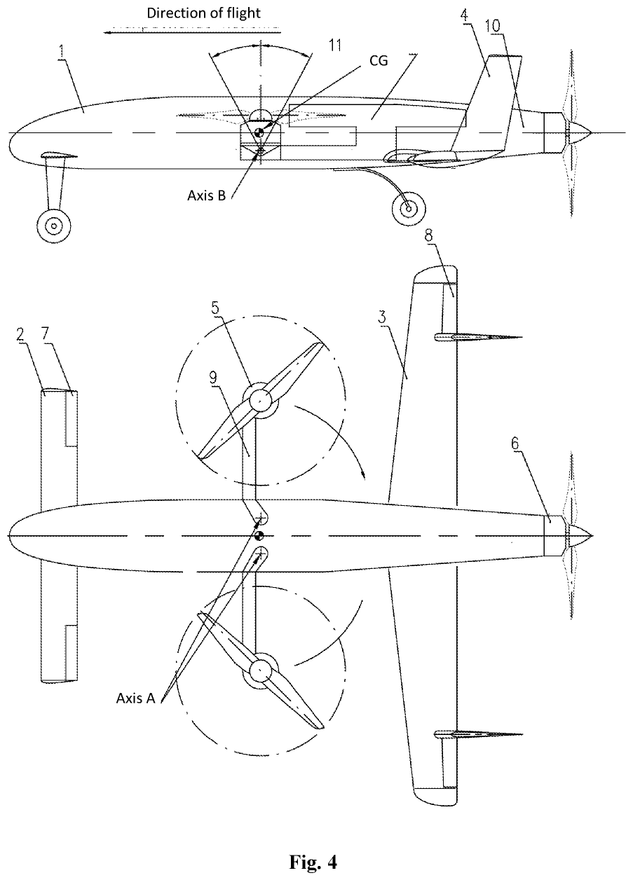

After takeoff all propulsion systems are turned forward to a certain angle to generate horizontal thrust (FIG. 2). Due to this the convertiplane accelerates to minimum horizontal flight speed. After this, the lifting propulsion systems are stopped and retracted into fuselage cavity by turning nacelles about A-axis (bank angle). When in horizontal flight (FIG. 3), the lifting force is generated by wings, thrust is generated by the propulsion system, and control is performed by differential controls (which could be installed as on front as and/or rear wings). If the propulsion system fails, landing is possible by means of lifting propulsion systems or by “glider” method—by differential controls, or (if available) by means of parachute.

If the propulsion system is rigidly mounted and there are no gas rudders that change a thrust vector in a vertical plane, in takeoff and landing mode the convertiplane is controlled only by lifting propulsion systems, and the propulsion system is either Off or running idle. The convertiplane is accelerated to minimum horizontal flight speed by turning the lifting engines forward to a certain angle to generate horizontal thrust, while the propulsion system is started for thrust generation. When minimum horizontal flight speed is reached, the lifting propulsion systems are retracted into fuselage. Horizontal flight and landing are performed similar to previous configuration.

If the propulsion system is rigidly mounted and comprises a jet engine and gas rudders that change a thrust vector in a vertical plane, the convertiplane is longitudinally controlled by these gas rudders, and by lifting propulsion systems and their pylons.

As compared with the prototype, the claimed technical solution has a variety of advantages, namely:

1. When the marching pylon has one degree of freedom, weight of empty convertiplane is decreased by 5% due to lack of roll mechanism. Besides, the structure is technically simplified.

2. When the propulsion system is fixed, weight of empty convertiplane is decreased by 10%, the structure is technically simplified and its reliability is improved, besides, there is a possibility of using combustion engines without controllable pitch propellers, that also results in weight decrease, structure and control system simplification and improves the convertiplane reliability.

3. Using of jet engine in the propulsion system enables the convertiplane to reach supersonic speeds.

4. If the propulsion system is rigidly mounted and comprises a jet engine and gas rudders that change a thrust vector in a vertical plane, the required power of the lifting propulsion systems is decreased and, accordingly, their weight and dimensions are also decreased, the marching pylon weight is decreased and its technical complexity is simplified due to lack of two degrees of freedom. As a result, the convertiplane flight range and time are increased, its technical complexity is simplified and reliability is improved.

1. A convertiplane comprising a fuselage, a pair of wings: fore and aft, a fin, two lifting propulsion systems comprising engines with propellers, located on pylons having two degrees of freedom with respect to angles of pitch and yaw on sides of the fuselage, configured to be fixed in a position and retractable during horizontal flight into a fuselage cavity, a marching propulsion system comprising an engine, the marching propulsion system is located on a marching pylon, wherein the marching pylon has only one pitch attitude degree of freedom and configured to be fixed in a position, or has no degree of freedom.

2. The convertiplane according to claim 1, wherein the engines of the lifting propulsion systems are made as electric motors, or as reciprocating internal combustion engines, or as gas turbine engines.

3. The convertiplane according to claim 1, wherein the propellers of the engines of the lifting propulsion systems are made foldable.

4. The convertiplane according to claim 1, wherein the lifting propulsion systems are made retractable forward or backward into the fuselage cavity.

5. The convertiplane according to claim 1, wherein the engine of the marching propulsion system is made as an electrical engine or an internal combustion engine, and the propeller of the engine has a fixed or variable pitch, and is made foldable.

6. The convertiplane according to claim 1, wherein the engine of the marching propulsion system comprises a jet engine and gas rudders that change a thrust vector in a vertical plane.

7. The convertiplane according to claim 1, wherein the marching pylon is located in a nose or a tail of the fuselage, or on leading or trailing edges of the fin.

8. The convertiplane according to claim 1, wherein it is made with a landing gear.

9. The convertiplane according to claim 1, wherein it is made with a parachute.
